(19) United States
(12) Patent Application Publication
(10) Pub. No.: US 2002/0188616 A1
(43) Pub. Date: Dec. 12, 2002

(54) Database access bridge system and process

(76) Inventors: Roberto R. Chinnici, Sunnyvale, CA (US); Ken Rodham, Gilroy, CA (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/875,054

(22) Filed: Jun. 7, 2001

(51) Int. Cl. G06F 7/00

(52) U.S. Cl. 707/102

(57) ABSTRACT

An interface is provided that enables a computer application designed for operation in a two tier system to operate in a three tier environment by enabling database record information modified at the client computer system to update a database server information without database protocol commands being initiated from the client computer system. Database record information is modified at the client computer system using a first computer programming language and transmitted with modifications to an application server. The modifications are converted, at the application server, to calls of a second computer programming language and the second computer language programming calls are executed to invoke functions of the computer application to cause database record changes at the database server that correspond to the modifications to the database record information.

### DESCRIPTION OF THE INVENTION

1. Field of the Invention

The present invention relates to database access systems, and more particularly, to a database access system in a three-tier computer system environment.

2. Background of the Invention

Computer application development tools, such as visual builder tools, are used to facilitate the development of computer programs. These tools generally include standard sets of software modules that may be interlinked to create custom-built applications.

One such widely used object-oriented visual builder tool is Visual Basic available from Microsoft Corporation of Redmond, Wash. Visual Basic has a graphical user interface (GUI) that facilitates the development of computer applications, such as database access applications. In addition to aiding in developing applications, Visual Basic may be used to manipulate data objects returned from relational data sources. The GUI of Visual Basic includes a “toolbox,” a “form window,” and a “property sheet.” A toolbox typically contains icons or text, which represent different classes of components or software modules. An example of different classes may include complex components (e.g., database viewers) and simple components (e.g., buttons). An application may be composed in the form window by selecting a component from the toolbox and placing it within the form window. A developer graphically composes an application by interlinking components in the form window. The components are interlinked based on properties or attributes relating to the selected component as displayed in the property sheet. The properties may include information relating to the size, color, and name of the selected component.

Many Visual Basic developers have substantial experience with two tier environments that involve applications for direct querying or access to a database. In a two tier environment, a client computer system (first tier) directly communicates with a database system (second tier) to access data. The second tier is often a relational database that uses Structured Query Language (SQL) as the protocol language for communicating with other systems.

With the advent of the Internet and the use of application servers, three tier environments are becoming more popular. In a three tier environment, a client system (first tier) has a GUI that communicates with an application running on an application server (second tier) which in turn communicates with a database server (third tier) for access to and storage of data. Because three tier environments enable business applications on the second tier to be modified without having to substantially modify each client system, a three tier environment may be more efficiently maintained and updated than a two tier environment that generally requires each client system to be modified when changes are desired. This advantage of the three tier environment has made many businesses consider switching to three tier systems.

One consideration businesses take into account when switching to different computer systems is the cost of training required for the developers and technical staff. For companies that have a significant number of developers trained only in two tier system language protocols, switching to a three tier environment may result in these developers not being able to use many of their previously learned skills. As a consequence, many businesses may be reluctant to switch to a three tier environment due to training time and cost concerns.

Furthermore, programmers may be reluctant to learn a new computer language.

For example, these developers may not be versed in the Java programming language, which is becoming the standard in many three tier environments. The Java ™ programming language is suited for use in a three tier environment due to programming conventions such as Java Beans (JB) and Enterprise Java Beans (EJB). EJB components may link other EJB components or may be designed to perform customized operations when invoked or called.

Some conventional systems enable applications, such as Visual Basic applications, to operate in conjunction with a three tier environment. However, these systems require Visual Basic application developers to learn a complex protocol interface language, such as DCOM, to interact with an application or middle tier server. Consequently, these application developers may be reluctant to learn a complex protocol interface language in order to develop applications that operate in a three tier environment. Given the existing skill base for programming in two tier environments, there is a need for methods and systems that enable computer program developers to continue to use their existing two tier skills in a three tier environment, without learning new computer programming protocols or languages.

### SUMMARY OF THE INVENTION

Generally described, systems and processes consistent with the present invention provide an interface that enables a computer application designed for operation in a two tier system to operate in a three tier environment by enabling database record information modified at the client computer system to update a database server information without database protocol commands being initiated from the client computer system. Other systems and processes consistent with the present invention enable a client computer system designed for a two tier database system to access and initiate operations of various levels of software components of an application server to invoke database calls.

In one aspect consistent with the present invention, the result of a query request as modified by a client computer system is received at the application server. At the application server, the modifications made to the result of the query request are determined. The modifications are converted from a first programming language into a general computer programming language command for accessing database. The general programming language commands are executed to produce database protocol commands to modify a database record to correspond to the query request as modified by the client computer system.

In another aspect consistent with the present invention a client computer system receives database record information. The database record information is modified at the client computer system using a first computer programming language and transmitted with modifications to an application server. The modifications are converted, at the application server, to calls of a second computer programming language of a computer application and the second computer language programming calls are executed to invoke functions to cause database record changes at the database server that correspond to the modifications to the database record information.

Additionally, it may be determined when a user has completed making changes to the database record information at the client computer system and a list of the changes is transmitted to the application server. The application server determines the changes that have been made to the database record information from the list and converts the changes to functions of the application that cause the specified modifications to a database record of the database server.

The database record information may represent at least a subset of a table of the database server and the table may be modified at the client computer system by inserting an element in the subset of the table. At the application server, a map is created to enable the insertion of elements or objects into a table of the database server that corresponds to modifications made at the client computer system. The EJB that operates on the corresponding modified table is located. At the application server, all create methods of the EJB object and of sub-objects of the EJB object are identified and the columns of tables of the database corresponding to arguments of identified create methods are also identified. A map is created that maps the columns to arguments of the create methods that correspond to the columns. The create method operative to insert the element provided from the client is executed, at the application server, to cause the element to be inserted in the table of the database.

In another aspect consistent with the present invention, a method of interfacing between a client computer system and a database server is provided. At an application server, a set of commands is received from a client computer system to modify a database record of a database server. Certain application instructions, at the application server, are identified that are operative to insert elements into a database record. The certain application instructions are correlated to certain commands received from the client computer system that indicate the insertion of an element into the database record. Selected certain application instructions are executed that correspond to the certain commands. Execution of the selected certain application instructions cause the invocation of a database call to insert elements into the database record corresponding to the certain commands.

In another aspect consistent with the present invention first level software components at an application server are identified that contain sub-level software components. The sub-level software components access data input fields of a database. Operations of the first level software components are exposed to the client computer system in association with operations of sub-level software components. Modification commands received, at the application server, from a client computer system are mapped to operations of the identified first level and sub-level software components that correspond to the modification commands. The identified operations of the software components are executed to update the database in accordance with the modifications received from the client computer system. The first level software components may be EJB objects and the sub-level software components may be sub-objects of the EJB object. The modification commands maybe from an application designed for direct access to a relational database. In this way the EJB object may add a layer or layers of abstraction to the data stored in the database.

### BRIEF DESCRIPTION OF THE DRAWINGS

FIG. 1 is a diagram of a network system in which methods and systems consistent with the present invention may be implemented;

FIG. 2 is a more detailed view of the components of the network system of Fig.1;

FIG. 3 is an example of information of a database that may be used in conjunction with an implementation of the present invention;

FIG. 4 is a diagram of a database bridge map consistent with an implementation of the present invention;

FIG. 5 is a detailed view of another implementation of a database server system of FIG. 1;

FIG. 6a is a flow diagram of the processes consistent with the present invention at a client computer system associated with modifying database record information;

FIG. 6b is a flow diagram of the processes that enable database protocol commands to be converted to application commands at an application server for processing;

FIG. 6c is a flow diagram of processes associated with mapping elements for insertion of an element into a table;

FIG. 6d is a flow diagram of processes consistent with the present invention for converting database protocol commands to a general computer programming language commands;

FIG. 7 is a flow diagram of processes consistent with the present invention for creating a database bridge map;

FIG. 8 is a flow diagram of processes consistent with the present invention for creating an object-oriented component consistent with the present invention; and

FIGS. 9-15 are flow diagrams of processes consistent with the present invention that are performed by an object evaluator to create the database bridge map.

### DETAILED DESCRIPTION

### A. Overview

Systems and methods consistent with the present invention receive modification information for database record information at an application server and convert that modification information to various hierarchical levels of general computer programming language commands that may be executed at the application server to modify information of a database. The modification information may be direct changes to database record information made at the client computer system rather than database protocol commands initiated directly from a client system to a database. The modification information may be transmitted to the application server where the application server determines the changes that have been made to the database record information. The modifications are then mapped to commands that may be implemented at the application server to effect the desired changes to database records.

Such systems and methods expose software components residing on the application server as database fields so that a client computer system can communicate with the application server as though the client computer system is accessing a database. The application server receives the database protocol commands or queries from the client computer system and a database bridge converts, via maps, commands or modifications from the client to general computer programming language commands of applications running on the application server. The converted commands are executed on the application server to access the database. The maps relate client associated commands to operations from various levels of software components, such as objects and sub-objects, and maps are created to enable inserts into database tables.

A system or method consistent with the present invention may use the Java™ programming language, particularly Enterprise Java Beans (EJB), for accessing a database. Java Beans is an object-oriented component architecture that enables the creation, assembly, and use of dynamic Java components. A Java component is the reusable software component module. Java Beans defines a standard set of interfaces and behaviors that enable a developer to build reusable Java components. The components can be linked together to create applets, applications or new beans for reuse by others.

When used in connection with the present invention, EJB components or objects may be utilized at the application server to access the database server. A database bridge exposes the EJB relationships for accessing the database as data fields. The database bridge serves as the interface between the database queries from clients and applications at the application server.

In order to expose the database fields that are accessed by the EJB components to a client application, a computer program module is executed that evaluates the EJB components at an application server to determine the methods or fields associated with the EJB components and sub-components. These methods or fields are then mapped to appropriate EJB components and are exposed to the client computer system. Thus, when the client computer system modifies database record information and submits changes, the changes from the client are executed against the created map to determine the corresponding EJB command (e.g. method) for accessing or creating the appropriate database field. The EJB command is invoked at the application server and performs the desired operation.

### B. Architecture

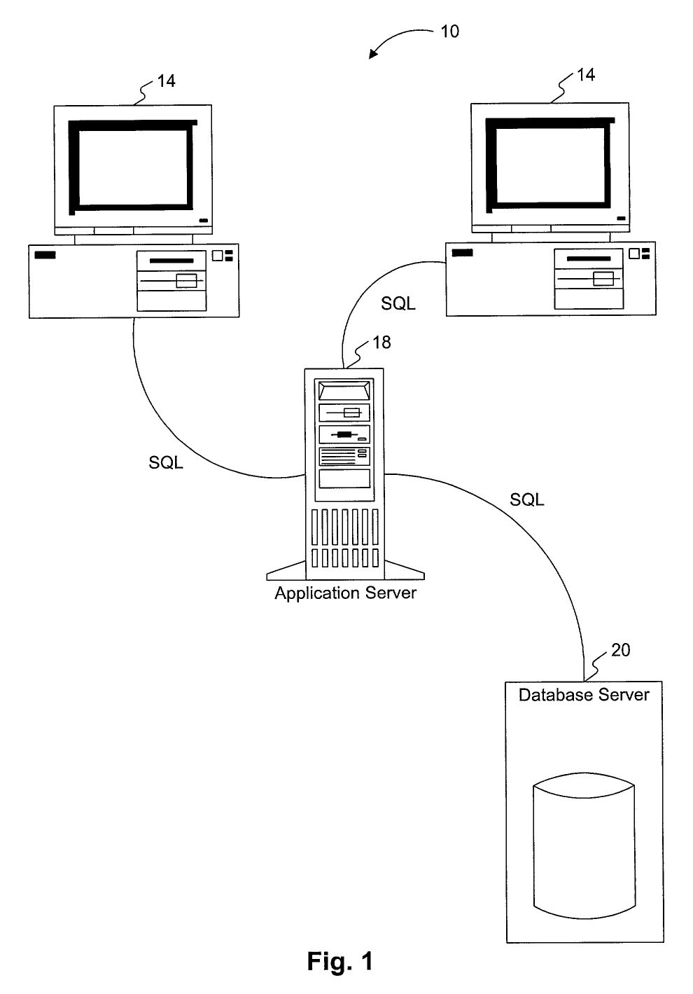

Referring to FIG. 1, a database bridge system 10 consistent with the present invention is illustrated. The database bridge system 10 includes client computer systems 14, an application server 18, and a database server 20. The configuration for each machine may be conventional but the operation of them is not, since it involves processes consistent with the principles of the present invention. The terms “client” and “server” are used to distinguish the roles of data processing systems where servers perform operations on behalf of clients or other servers. Although the terms “client” and “server” are used herein to describe certain devices, those skilled in the art will recognize that any data processing system may be implemented as either a “client” or “server” depending on programmed functions and “clients” and “servers” may reverse roles with clients performing server functions and servers performing client functions. The client computer systems 14 may communicate with the application server 18 in a database access protocol, such as SQL, or in a communication protocol such as HTTP. The server 18 then translates client commands to application logic that in turn produces a set of SQL commands for transmission to database server 20.

In a two tier client-server environment, the client applications establish a direct connection with a database server, such as a SQL server, to submit queries to the database server. The client connects with the server over a local area network (LAN) or a wide area network (WAN). The client submits these queries in an SQL format to a database engine for processing and receives the results returned from the engine. The SQL protocol command is formatted as a tabular data stream (TDS).

In a database bridge system consistent with the present invention, the client computer initiates a query to obtain a record, such as a relational database rowset, which when returned may be operated on and/or updated at the client computer system. A rowset is a database structure containing information that represents a row or multiple rows (subset) of a table of the database, where each row may contain several fields. The fields are defined by the columns of the table. Instead of communicating with the database directly to effect the changes, the rowset changes or SQL commands are transmitted to the application server from the client computer system. The application server then converts the SQL protocol command or rowset changes to a programming language call and executes the programming language call according to business rules and logic at the application server. The business rules and logic at the application server may provide database access constraints, access verification to database fields, or any other desired processing requirements for database access.

For example, when the client computer system 14 sends requests or queries to access certain information from the database, such as an employee's information record, the application server 18 converts the request for the employee's information record to an EJB method for obtaining the record from the SQL server. The application server 18 then executes an EJB component corresponding to the EJB method to produce an SQL command that accesses the database server 20. EJB components for interfacing with the database 20 may be generally referred to herein as the EJB layer. The view of database fields (e.g. field names and structure) or operations that the client application operates on (sees) may be different than the underlying field names used in the EJB layer for accessing information in the database. When the EJB component executes, an SQL command is provided to the database server 20 to retrieve the information requested by the client computer system 14.

For simplicity of the drawings, many components of data processing systems, including computer systems and servers, have not been illustrated, such as address buffers and other standard control circuits because these elements are well known in the prior art and are not necessary for understanding the present invention. Computer programs and modules used to implement the various steps of the present invention are generally located in a memory unit, and the processes consistent with the present invention are carried out through the use of a central processing unit (CPU) in conjunction with application programs or modules. Those skilled in the art will appreciate that the memory unit is representative of both read-only memory and random access memory, or other memory elements used in a computer system. The memory unit also contains databases, tables, and files that are used in carrying out the processes associated with embodiments of the present invention. The CPU, in combination with computer software and an operating system, controls the operations of the computer system. The memory unit, CPU, and other components of the computer system communicate via a bus. Data or signals resulting from the processes of the present invention are received and output from a computer system or server via an input/output (I/O) interface.

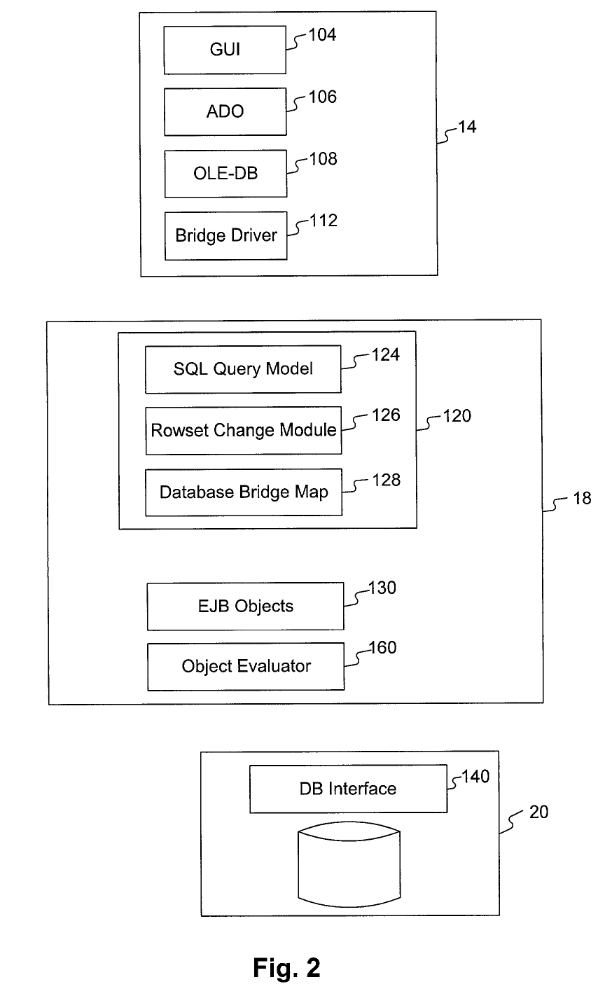

Referring to FIG. 2, application program modules stored in the memory of a client computer system 14, application server 18, and database server 20 are illustrated. When executed by processors associated with the respective machines, the modules perform the functions described herein. As discussed above, the client computer system 14 communicates with the application server 18 in a database access protocol language as though the application server 18 is a database. In essence, the application server 18 is presented to the client computer system 14 as a database. Applications at the application server 18 convert the client database access protocol commands, for example, rowset change commands, to appropriate general programming language commands which are executed to access and operate on the data as specified by client computer system 14.

The client computer system 14 contains a client application, such as a GUI 104, that permits a user to interface with the application server 18. GUI 104 may be implemented using Visual Basic. This Visual Basic application may use database access technology, such as ADO (ActiveX Data Objects) API 106 from Microsoft Corp., which may in turn be built upon an interface such as the Microsoft OLE-DB interface 108. OLE-DB is a Microsoft COM API for database access. The Microsoft OLE-DB interface uses database drivers to talk to target databases. In this case, the database driver is a bridge driver 112 that forwards the database requests to the database bridge running in application server 18. The result of the database request may be returned to the client for viewing and/or manipulation.

The application server 18 contains EJB objects 130 that process SQL queries and rowset set changes received from GUI 104. The client changes or queries are processed through a database bridge 120 that provides the interface between GUI 104 and EJB objects 130. The database bridge 120 may be defined as a “bridge” class to implement its command conversion functions. The bridge class contains a query model, such as a SQL query model object 124, to process queries from GUI 104 and a rowset change module 126 to process rowset changes from the GUI 104. The SQL query model object 124 may be a “finder” interface, as defined in EJB. The bridge 120 contains a database bridge map 128 that has methods for mapping commands between the client application 104 and EJB objects. If the client commands are SQL commands, they are mapped directly to EJB objects 130 and the objects are executed. The EJB objects 130 develop and send SQL queries to the database server 20.

If the client commands are changes to rowsets, the rowset change module 126 evaluates the rowset and list of changes received. The changes are mapped from API commands to corresponding EJB objects. The changes are in the form of a list of changed rows. For each row, the client sends a value corresponding to each column. The value is a conventional “ignore” value if there were no changes to that column, of the new value if there were changes. For purposes of optimistic locking, the client may also send the old value. The EJB objects 130 executed and produce SQL commands for performing the operations at the database that correspond to the client changes. The updates corresponding to the SQL commands are received and executed in the database.

A database interface 140 processes the SQL queries and accesses the database 150. The data of an SQL database is relational. That is, the database stores information in a table or relation format. A table has a set of rows and columns with columns defining fields in a row, and a row defining a collection of fields that represents one instance or record of data.

The EJB objects 130 have methods and properties defined for accessing the appropriate tables and fields of the database. However, the client application does not have direct access to the database, but instead has access through the EJB objects. As a consequence, a map is created to correlate queries or commands from the client application to EJB objects for executing those commands. In order to map client initiated commands to EJB objects to access the database, the properties and methods of the EJB objects that are used to access the database are determined to create the database bridge 120.

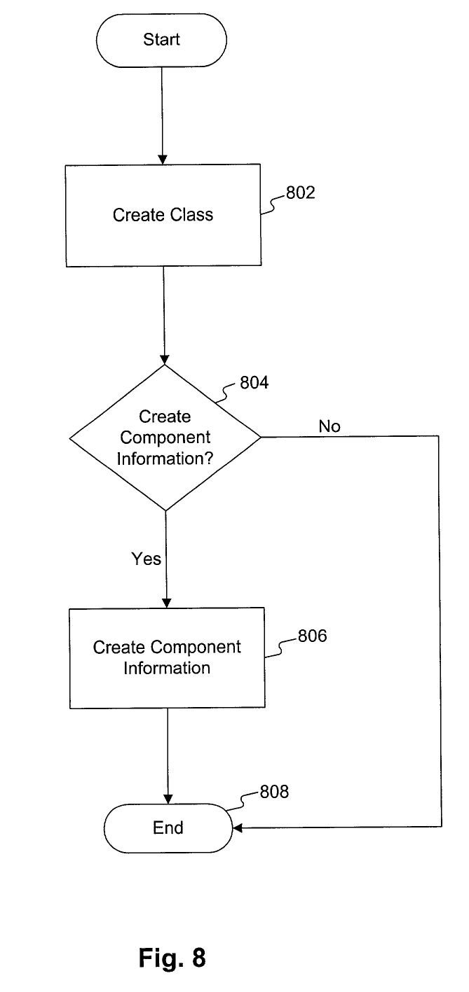

An object evaluator 160 in application server 18 determines the properties and methods of the EJBs. Each time an EJB object is added to the EJB objects 130 for accessing database elements, the methods and properties of the EJB objects are determined by the object evaluator 160. The object evaluator 160 is executed to identify “getXXX,” “setXXX,” in the target EJB and its sub-objects. These methods are mapped as properties in the database bridge 120 to correspond to the database field or object that the method operates on. The properties or objects are exposed as SQL fields in the database bridge 120. The operation of the object evaluator 160 is described in more detail below in connection with FIGS. 8-15.

The EJB objects 130 may add a layer or layers of abstraction to the data stored in the database. For example, the EJB objects may add constraints between fields or provide higher level semantics. The database bridge 120 provides a database or SQL view onto the EJB objects. Consequently, an application tool, such as Visual Basic program, believes it is communicating directly with SQL to a database, although it is actually communicating with an EJB application server, which then communicates with the database, and thus adds a layer of abstraction.

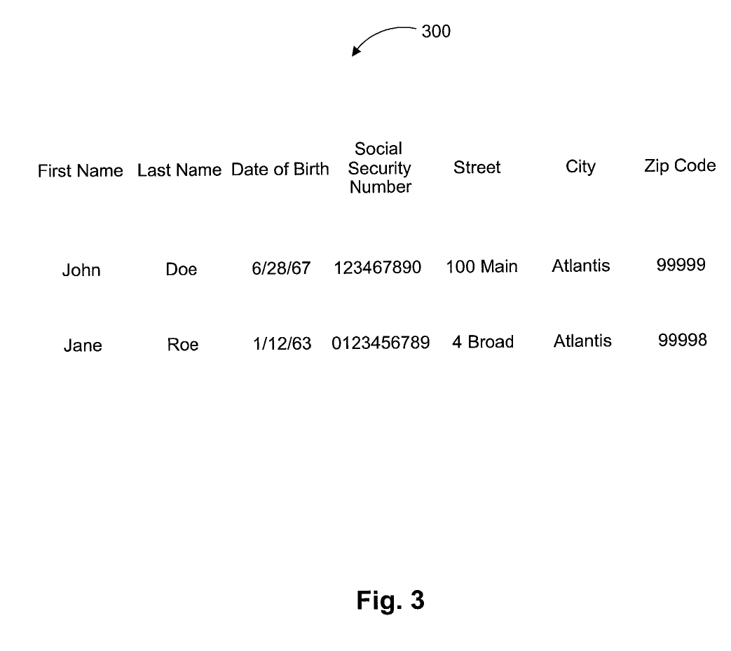

Referring to FIG. 3, an employee table 300 for storing employee information in database 150 is illustrated. The employee table 300 contains rows of employee data. Seven columns or fields of the rows are illustrated: first name, last name, date of birth, social security numbers, street, city, and zip code. The data stored in the employee table 300 is accessed by executing the EJB objects 130 of the application server 18. The executed EJB objects are converted into a data manipulation language, such as SQL, to formulate a query to access the database. For example, a query can be used to retrieve all rows of the employee table, selected rows of the employee table, or selected fields. In addition to storing application data, the database 150 uses tables to store schema data, or meta data. Meta data contains information that describes the structure of the data stored in a database. For example, meta data identifies the tables contained in the database and the specifications for the columns in each table.

Table 300 illustrates the basic structure of data contained in a table of the database. A user may initiate a query to obtain information from one or more fields. For example, the user may request, using a two tier GUI, modification of or access to information of a specific field, such as the “date of birth” field or “street” field. To obtain this information in a manner consistent with the present invention, the two tier system communicates with an EJB layer of an application server rather than directly with a database. The two tier system communicates or operates with the database through EJB objects of the application server 18. The database bridge 120 of the application server not only maps or exposes the top level objects or methods to commands of the two tier system, but also maps or exposes sub-objects (e.g. methods of sub-objects) to commands that may be received from the client. Thus, when creating a map for EJB objects, not only is the top level of EJBs evaluated for mapping, but sub-levels are evaluated and mapped for use in database access. By using a system consistent with the present invention, programming environments may be efficiently accommodated where developers use multiple layers or sub-objects to operate on data of an underlying database.

In the table 300, the object layer of the application server may provide a method that directly accesses data (or property) in each field individually. For example, database elements or fields may be accessed for manipulation by a single “get” or “set” method. However, some developers may prefer to use several layers of objects or sub-objects in the application server to access database elements. For example, rather than providing “get” and “set“ methods at the top level of EJBs for each field of the database, a developer may prefer to expose information of an employee object through sub-objects, such as personal information and address information sub-objects. That is, an employee object may have defined sub-objects “personal information” and “address information.” These sub-objects have methods for accessing specified fields of the database. The information of the database may thus be exposed through a method “get personal information,” which returns the information of the first name, last name, date of birth, and social security number fields. Likewise, address information of the employee object may be exposed through a method “get address information,” which returns information from the street, city, and zip code fields.

To enable a map to be developed to account for sub-objects, a process of the object evaluator 160 consistent with the present invention recursively introspects the sub-objects of each object until the sub-object that accesses the fields of the database is located. Introspection is a process that analyzes an object to determine its properties and methods. Unlike “reflection,” which returns a list of the fields and methods defined for an object, “introspection” returns higher level entities, such as properties and events, which are realized in an object by several methods following certain programming conventions (such as: a pair of getFoo( )/setFoo( ) methods determines a readable and writable property whose name is “foo”). These conventions create relationships for the methods described above when, in fact, they would appear unrelated when examined using an operation such as reflection. The hierarchical sub-object structure of an object, as determined during the introspection, is thus used to define the map. The methods of the located sub-objects are used to define or specify the columns/fields that are mapped to commands from a client. Thus, to “set” a city value associated with the address information sub-object, a “get” address information operation followed by a “set” city operation would be performed to set the city value of the “address” sub-object to a specified city. The object evaluator 160 determines the sub-object structure of a specific object to construct the map used in mapping commands from a client to the EJBs by recursively introspecting objects and sub-objects. Rather than providing a direct mapping of each command to the sub-object that accesses a field of the database, the sub-object structure is preserved in the mapping process by mapping a command from a client to the succession of sub-objects that are called to obtain the particular information associated with a field of the database or a group of fields that may be accessed sub-object hierarchy.

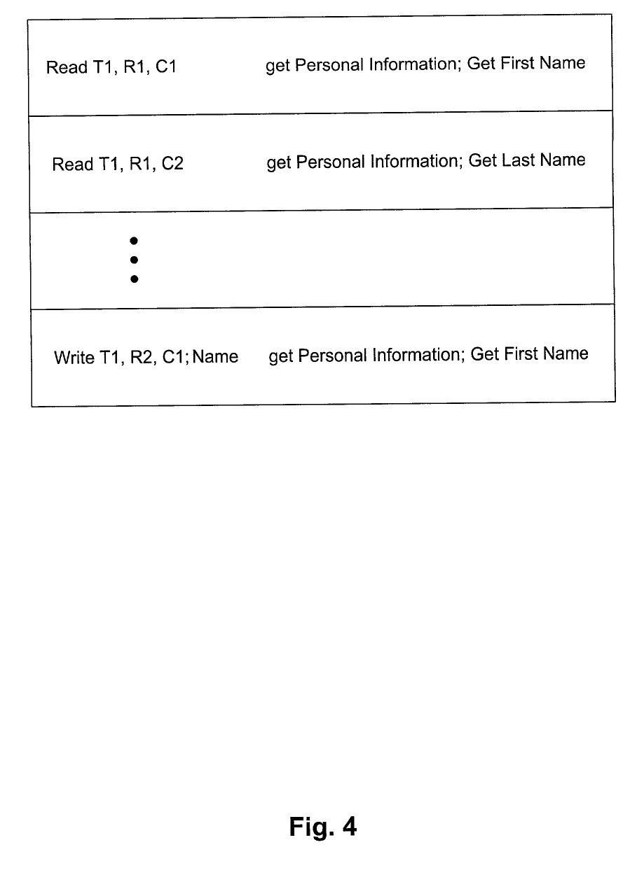

Referring to FIG. 4, an example of a database bridge map 128 is illustrated. In a map consistent with the present invention, the database bridge map 128 maps commands from a client to EJB methods/properties. The database bridge map 128 contains commands that may be SQL commands that may be initiated from a client computer system 14 or commands that are the result of evaluating changes to rowsets received from a client. The commands resulting from the client are mapped to EJB methods and properties, used to invoke a designated function in the database, to the client commands or operations that perform the functions and to the database elements that are the target of the functions. Thus, when the application server 18 receives a command or set of changes from the client computer system 14, the commands corresponding to the client changes or request are matched to EJB methods that, when executed, perform the desired operation on the appropriate database element. More specifically, for each change made to a column of a particular row in a change set received from a client, the application server accesses the corresponding bean using, for example, the primary key of the row as the primary key for the bean and then invokes a setter/update method to alter the value. If case optimistic locking is being used, the server checks that the current value of the property corresponding to that column is the one the client sent as the “old” value before setting the new value as described in the previous paragraph.

The commands, as represented FIG. 4, specify a table, T, row, R, column, C, or universal character, such as “*” that is used for requesting multiple elements in a single command. For example, if a client computer system initiated, from Visual Basic, a “select FirstName” command, that command would be converted to a command 402. The command 402, for example, is a database read command that reads table 1, row 1, column 1. Consistent with the present invention, the command 402 is mapped to two methods, “getpersonalinformation” followed by “getFirstName,“ of a corresponding EJB and these methods are executed in succession at the application server 18. The employee first name of database 150 that corresponds to the “getFirstName” method is returned to the application server 18 for transmission to the client computer system.

The command 408 is an example of a command that writes data to a field of the database 150. The command 408 may be generated from a client computer system 14 in an application, such as a Visual Basic application, when an “update FirstName” command is executed. The command 408, as received from a client computer system 14, updates table 1, row 2, column 1 which is the first name of the second employee listed in table 1 of the database 150. The command 408 is mapped to “getpersonalinformation“ followed by a “set” EJB method, such as “setfirstName”, to modify the first name of the employee as specified in the command.

It should be appreciated that a command from a client computer system may be mapped to one or more EJB methods depending on the sub-object structure of the relevant EBJ. Those skilled in the art will also appreciate that the command that is mapped to the EJB methods may originate directly from the client computer system or may be a command that is determined at the application server 18 that corresponds to user changes to rowsets that are submitted to the application server 18 from a client computer system 14.

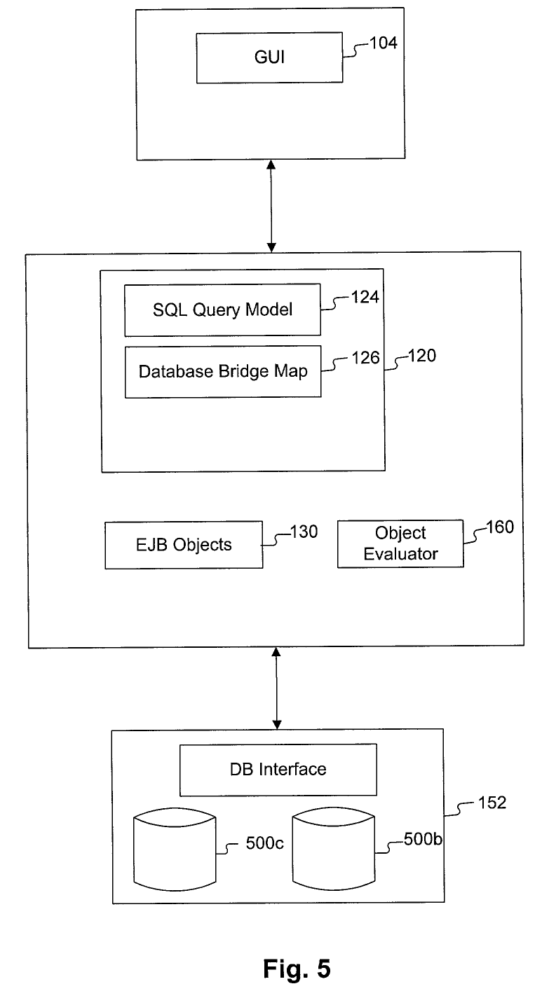

Referring to FIG. 5, a diagram of a system consistent with the present invention is illustrated that has a database server 152 that accesses two databases 500a and 500b. Many companies, for various reasons, have multiple databases that separately store different types of information, such as employee information, but decided that being able to access the separately stored information with a single request is better. For example, a company may have an employee payroll database and an employee vacation database that the company desires to access as a unified set of information. In this situation, a program developer develops a single EJB that accesses each database. The EJB would have a “getvacation” method and “getSalary” method that would be routed to the separate databases when the EJB method is invoked. As discussed above, the object evaluator 160 exposes methods of EJBs and, in this case, the object evaluator 160 is executed with respect to the single access EJB to expose the separate database access methods of the single access EJB object. The exposed methods are used to produce or update the database bridge map 128. In this example, because the databases may have fields or database elements that are duplicated, such as an employee name, an EJB may be written that updates more than one column or database in response to a single update command received from the client. Similarly, the incoming database call may specify different columns and/or table layouts than the command sent to the underlying database or databases.

### C. Processes

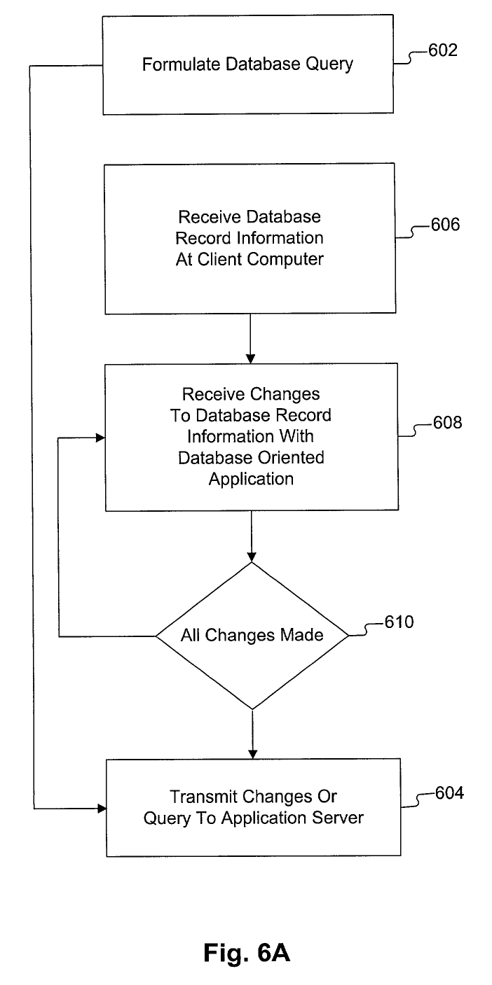

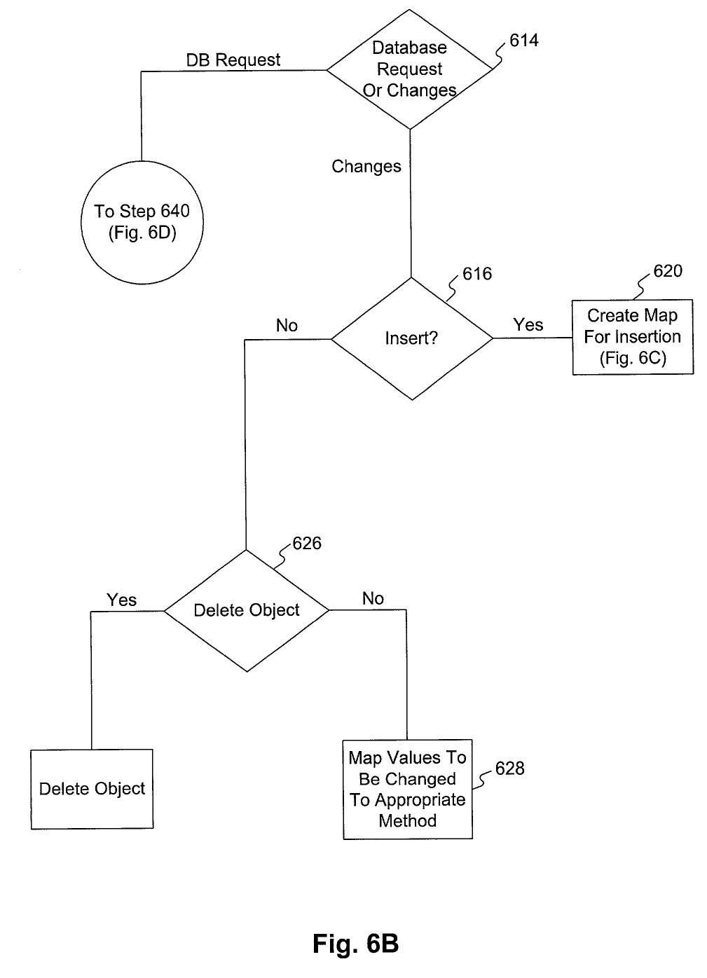

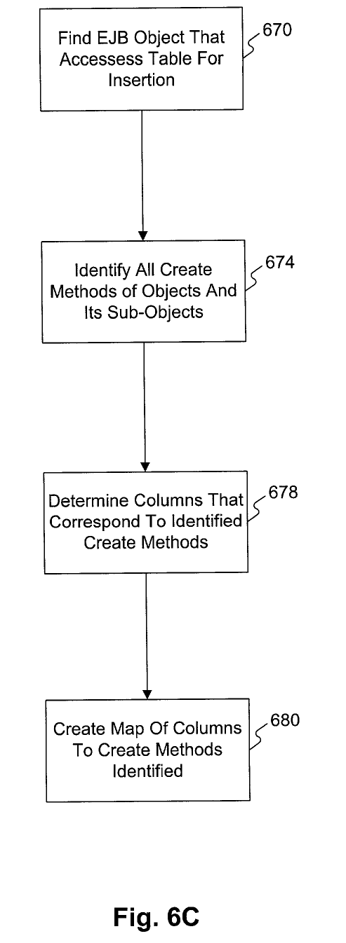

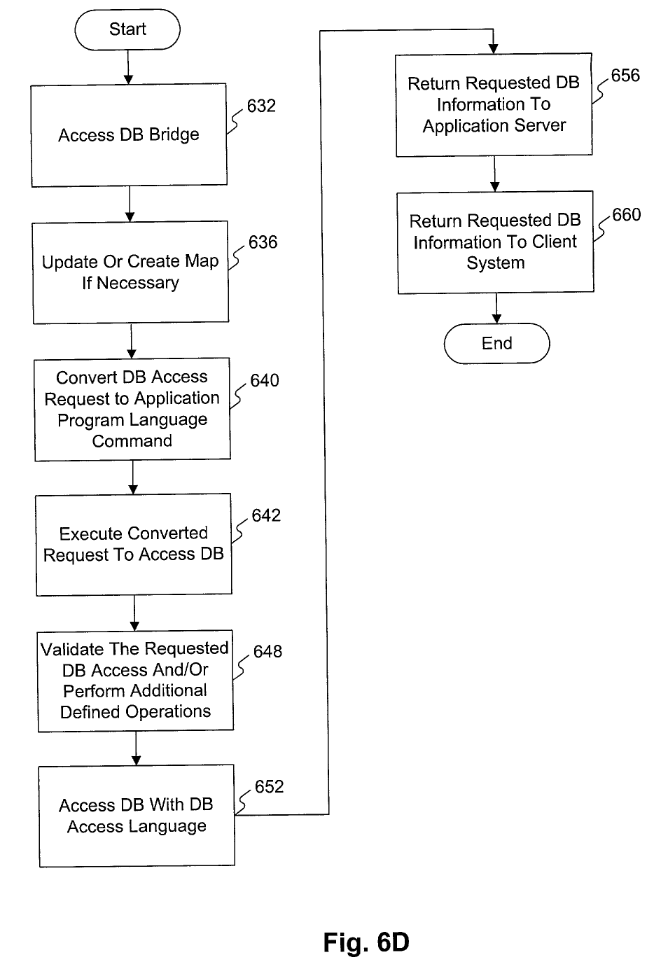

Referring to FIG. 6a, processes consistent with the present invention are shown for database access and modification in a three tier computer environment using a client computer GUI application designed for operation in a two tier computer environment. As noted above, by using a method or system consistent with the present invention, a program developer versed in two tier applications does not have to learn three tier programming techniques in order to operate in a three tier environment. The processes consistent with the present invention enables a two tier GUI to communicate changes for a database by initiating direct database calls or by making changes to rowsets directly at the client and transmitting those to the application server. Thus, changes can be made at the client computer system to a rowset to effect corresponding changes in the database without database protocol commands having to be constructed at the client computer system.

A user desiring to receive information from records in the database formulates a query to obtain the desired information (step 602). The query is then transmitted to the application server 18 for processing (step 604). After a query has been processed at the application server 18 to obtain information from the database 20, the database 20 responds by providing the result of the query back to the client computer system (step 606) via the application server 18. The result of a database query will often contain a rowset that corresponds to the information of the database record requested by the client computer system. At the client computer system 14, a user can use the two tier GUI, such as Visual Basic, or other known application interfaces to modify rowsets received (step 608). The user may update, insert, or revise values in the rowset at the client computer system that will be applied at the database without the client computer system initiating database protocol commands to modify information in the database. A list of changes made to the rowset is built as changes are made to the rowset at the client computer system (step 608). When all changes have been made to the rowset at the client computer system 14 (step 610), a command at the client computer system 14 may be selected to send (commit) the rowset and the corresponding list of changes to the application server 18 for processing (step 604).

FIG. 6b is a flow diagram of the processes that enable database protocol commands to be converted to application commands at an application server for processing. A client computer system programmed to operate in a two tier computer system environment may operate in a three tier environment via processes consistent with the present invention, as discussed in connection with FIG. 6b. When a system consistent with the present invention intercepts a database protocol request or client changes to an element representative of a database element from a client computer system 14, a determination is made whether the data from the client computer system is a database protocol request or changes to a rowset (step 614). If the data is a database protocol request, the process proceeds to map the database request to an appropriate command at the application server (step 616). If, however, the data is a rowset, the process determines whether an insert command has been issued by the client computer system for the insertion of a row (or object) into the rowset. If a row has been inserted into the rowset, a mapping for insertion is created (step 620) as discussed in more detail in FIG. 6c. If changes to a rowset do not constitute the insertion of a row, it is determined whether a row or object of a database element is to be deleted (step 626). If a row is to be deleted (step 626), the EJB corresponding to the rowset is located, then deleted. If a row is not to be deleted, the change in values of the rowset are evaluated and mapped to initiate the appropriate set method of the EJB corresponding to the value to be changed of the rowset (step 628).

Referring to FIG. 6c, if a row is to be inserted into a table, the EJB objects are searched to locate the object that accesses the table that is to have an element or object inserted (step 670). After the EJB object is located that accesses the table, all create methods of the EJB object and its sub-objects are located (step 674). Next, the columns that correspond to arguments of the identified create methods are determined (step 678). A map is created that maps the columns to the corresponding create methods of the identified EJBs (step 680).

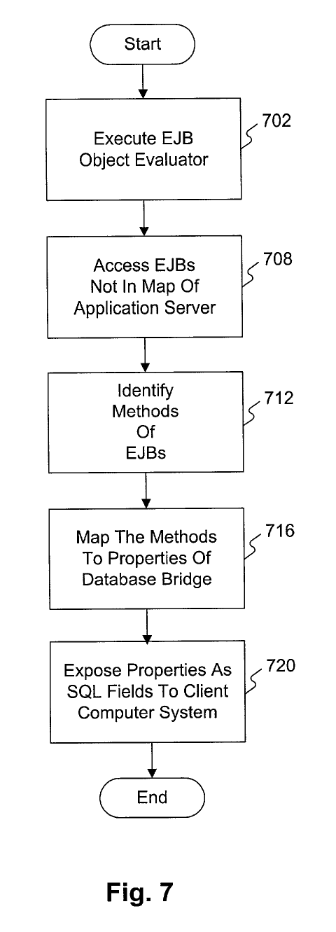

Referring to FIG. 6d, after the client request has been processed as discussed above, the system accesses the database bridge (step 632). If a database bridge map 128 has not been created or if an EJB has been added to the EJB objects for accessing the database (step 636), the database bridge map 128 is updated or created as discussed in connection with FIG. 7. If the database bridge map has been created for the EJB objects and all new EJB objects have been included in the database bridge map (step 636), the process proceeds to convert the database access request to an application program language command, such as an EJB method for accessing the database (step 640).

After a database access request has been converted to an EJB method, the EJB method is executed (step 644). Application logic at the server may validate that the request is allowed or may perform some additional operations with respect to the request that is defined for the system (step 648). After operations defined by EJB logic has been completed at the application server 18, the database is accessed from the application server 18 with a database protocol language corresponding to the database access request from the client computer system (step 652). The database returns the requested database information to the corresponding to the original client computer system request to the application server (step 656). The application server 18 transmits the information returned from the database to the client computer system 14 (step 660).

FIG. 7 is a flow diagram of the processes of the object evaluator 160 for defining elements to be included in the database bridge map 128. The database bridge map 128 can be created or updated prior to any requests being initiated from a client computer system 14 or may be updated or created in real time when the application server receives a database request from the client computer system. With the Java programming language, programs can be compiled at run time and consequently the database bridge may be updated or created when a request from the client computer system is received.

When the object evaluator is invoked to update or create a database map (step 702), the EJBs that are used in the database access process and that have not been included as part of the database map are accessed (step 708). The object evaluator may use a reflection process and design patterns, as discussed below, to identify methods of the EJBs that are used to access the database (step 712). The methods are mapped as properties (step 716) of the database bridge 120 to correspond to SQL commands that the methods access as discussed herein (see e.g. FIG. 4). The properties of the bridge are exposed to the client computer system as SQL fields (step 720), so that SQL requests can be converted to general programming language commands, EJBs, for execution at the application server.

The process of the object evaluator 160 for determining the methods of Java Beans that are used to access a database is discussed in more detail below. As discussed above, the methods of Java Beans used to access database are determined so that these methods can be exposed as properties of bridge class that maps SQL commands to these properties. This process is discussed in detail with respect to Java Beans, but it should be appreciated that other programming conventions may be used to implement the following process.

When applications, such as database access applications at the application server 18, are composed using application builder tools which manipulate software components, e.g., Java Beans, the application builder tool analyzes the components to determine the methods, properties, and events associated with the component. A Java Bean component that is a part of a Java Bean class may have an associated class which specifies details pertaining to the methods, properties, and events of the Java Bean. This class is known as a “BeanInfo” class, which may be considered to be an information class. The BeanInfo class typically includes strings which provide descriptive names that may be used to provide information about, or otherwise identify, the methods, properties, and events associated with a Java Bean. In general, a Java Bean will have a visual representation, or a representation that may be displayed as part of a graphical user interface. However, it should be appreciated that in some embodiments, the Java Bean will not have a visual representation, but will instead be modifiable using standard property sheets or the like.

As properties and events are typically identified by groupings of methods, a BeanInfo class, or an object that is a part of a BeanInfo class, generally includes methods that describe the Java Bean. Although the BeanInfo class may include any number of methods, the BeanInfo class consistent with the present invention may include the following methods: a method which returns other BeanInfo objects that have information relating to the current, or associated, Java Bean (“getAdditionalBeanInfo”); a method which provides overall information about the current Java Bean (“getBeanDescriptor”); a method which returns an index of a default event (“getDefaultEventIndex”); a method which returns an array which describes the events which may be exported by the current Java Bean (“getEventSetDescriptors”); a method that returns an array of externally visible, e.g., public, methods supported by the current Java Bean (“getMethodDescriptors”); and, a method that returns an array of editable properties supported by the current Java Bean (“getPropertyDescriptors”).

An application builder tool or other tool which analyzes a Java Bean may be provided with an Introspector class, as defined in Enterprise Java Beans. The Introspector class includes information relating to various design patterns and interfaces which are used with the process of introspection. Further, the Introspector class enables the BeanInfo object which describes a particular Java Bean to be obtained. In order to gather information relating to methods, properties, and events that are supported by a Java Bean, e.g., a target Java Bean, an Introspector typically analyzes the class, e.g., target class, with which the Java Bean is associated to determine if a corresponding BeanInfo class exists. In the event that a BeanInfo class exists, the Introspector uses information obtained from the BeanInfo class, in the determination of how to present the Java Bean.

It should be appreciated that a BeanInfo class may not exist for a particular Java Bean. If a BeanInfo class does not exist, an application builder tool may identify the methods, properties, and events associated with the Java Bean by using an automatic analysis, or a combination of a “reflection” process and a “design pattern” analysis. A reflection process, as is well known to those skilled in the art, generally involves studying parts of a software component, e.g., a Java Bean, that is a part of a program at run-time to determine the methods that are associated with the software component, such as a component to access a database. A design pattern is a pattern, or a syntax, that characterizes a particular method. Hence, a design pattern analysis is the analysis of syntaxes in order to identify the methods associated with a software component. As properties and events are usually identified by groupings of methods, a design pattern analysis also serves to identify properties and events. Generally, automatic analysis uses a reflection process to determine methods, such as “get” and “set” methods that are supported by a Java Bean, then applies design patterns to determine, based on the methods, which properties (e.g. FirstName, LastName, etc.), events, and public methods are supported. The use of automatic analysis enables methods and, therefore, properties and events, to be efficiently identified in the event that a BeanInfo class does not exist for a particular Java Bean. It should be appreciated, however, that even if a BeanInfo class exists, automatic analysis may also be used.

If a component is to include information pertaining to methods, properties, and events that are associated with the component, a class for the component information is created at the time the class is created. FIG. 8 is a flow diagram that illustrates the process associated with creating a new class. After a new object class is created (step 802), a determination is made (step 804) whether component information, such as a “BeanInfo” object, is to be created. The component information may generally include properties, methods and events for a component, or an instance of the class created.

If it is determined (step 804) that component information does not need to be created, then the process of creating a new class ends (step 808). P On the other hand, if it is determined (step 804) that the creation of component information is necessary or beneficial, the component information is created (step 806). The BeanInfo object may include a “getBeanDescriptor“ method which provides overall information, e.g., a display name, about the bean class. After component information is created, the process of creating a new class is completed (step 808).

The determination of which methods, properties, and events are associated with a class may occur sequentially, i.e., the methods, properties, and events may be identified in separate processes. Alternatively, the methods, properties, and events may be identified together as a part of a single process.

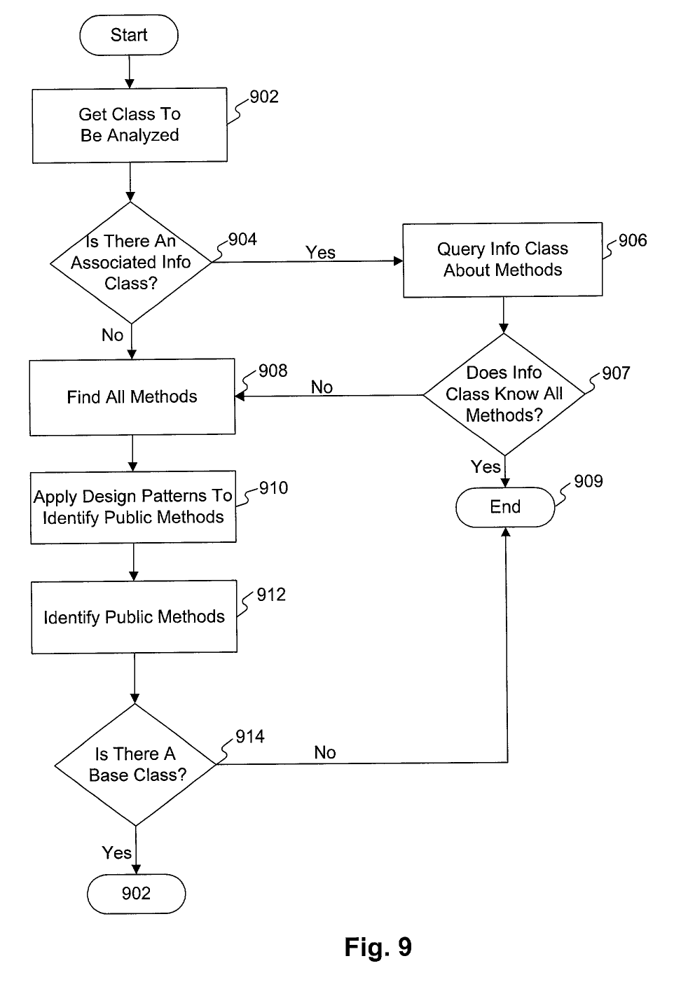

FIG. 9 is a process flow diagram that illustrates the steps involved with identifying methods associated with a class which may include an information class invention. After the class to be analyzed is obtained (step 902), it is determined (step 904) whether an information (info) class, such as a component information class, is associated with the class to be analyzed exists.

If an associated component information class exists, the information class is queried about methods contained within the information class (step 906). It is determined whether the information class “knows,” or includes, all methods associated with the class that is being analyzed (step 907). If it is determined that all methods are known to the information class, then the process of identifying methods associated with a class ends (step 909). If it is determined that all methods are not known to the information class, all methods associated with the class that is being analyzed are found. While any appropriate method may be used to find methods, a reflection process, is typically used to identify all methods associated with a class. As previously described, reflection involves studying different parts of a program, including the class that is being analyzed, at runtime to determine which methods, properties, and events are associated with the class.

After all methods are identified, design patterns are applied to identify public methods (step 910). The design patterns are typically standard design patterns that may be used to identify public methods, or a sub-set of methods which may be exported, that are associated with the class that is being analyzed. The public methods are then identified (step 912). Once the public methods are identified (step 914), it is determined whether there is a base class, or another class to be analyzed (step 914). When it is determined that the top-level base class has already been analyzed, the process of identifying methods is completed (step 909). If it is determined that there is a base class (step 914), the base class is obtained to be analyzed (step 902).

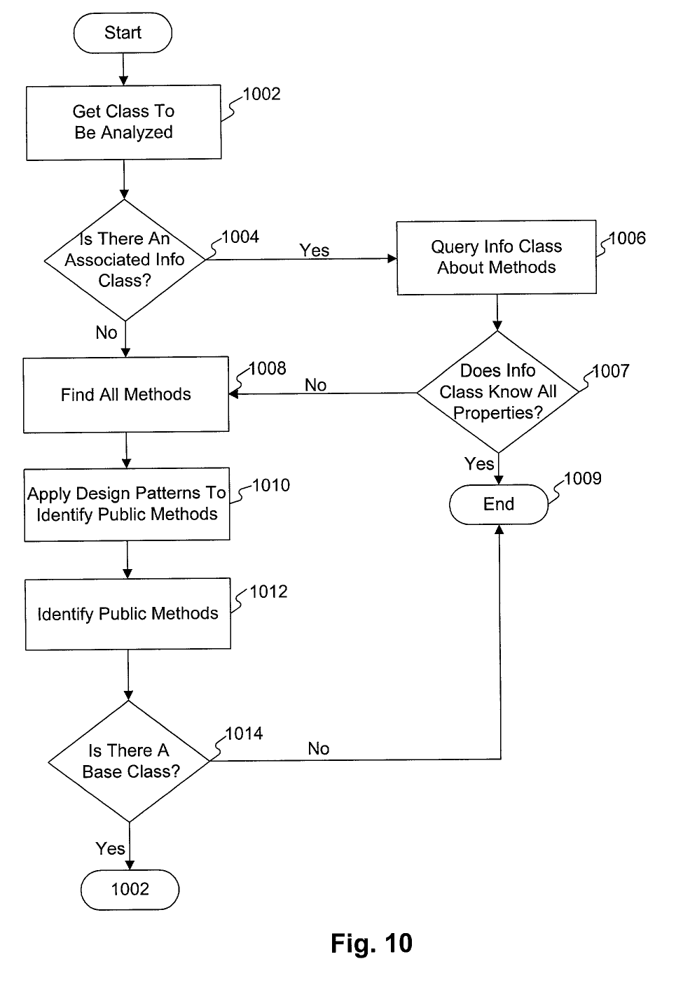

FIG. 10 is a process flow diagram that illustrates the steps for identifying properties associated with a class. Properties, which are generally named attributes associated with a class, may be read or written by calling appropriate methods which are associated with the class. Properties may include, but are not limited to, simple properties, boolean properties, and indexed properties.

After the class to be analyzed is obtained (step 1002), it is determined whether an information (info) class, such as a component information class, is associated with the class to be analyzed exists (step 1004).

If an associated component information class exists, the information class is queried about properties contained within the information class (step 1006). If the information class “knows,” or includes, all properties associated with the class that is being analyzed, the process of identifying properties associated with a class ends (step 1009). If all properties are not known to the information class, all methods associated with the class that is being analyzed are found (step 1008). While any appropriate method may be used to find methods, a reflection mechanism is typically used to identify the methods associated with a class.

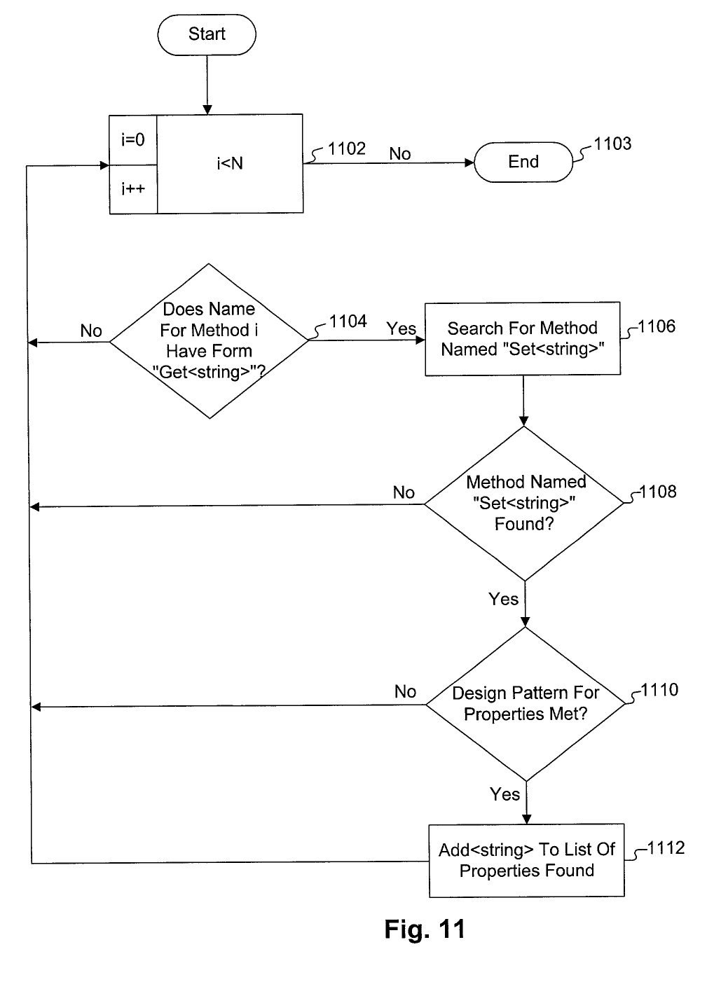

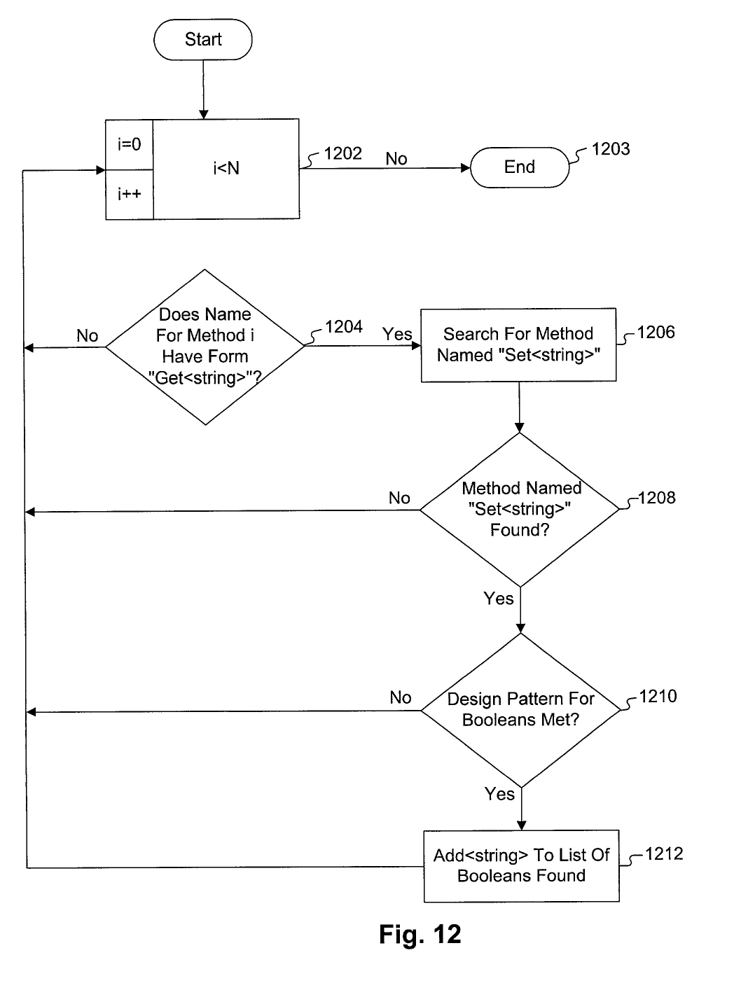

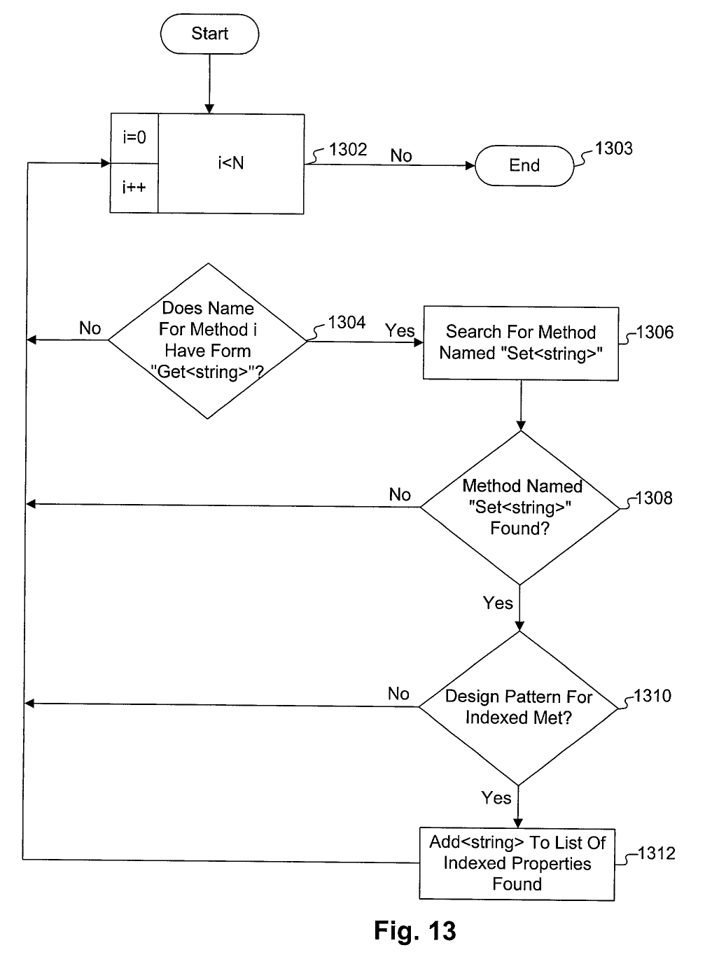

After all methods are identified, design patterns are applied to identify public properties (step 1010). As previously mentioned, properties may include simple properties, boolean properties, and indexed properties. Public properties are properties which may be exported to other classes. The steps associated with using design patterns to identify public simple properties is described in more detail with respect to FIG. 11, while the steps associated with applying design patterns to identify public boolean properties and public indexed properties is discussed in more detail below with reference to FIGS. 12 and 13, respectively. After the design patterns are applied (step 1010), the public properties are identified (step 1012).

After public properties are identified (step 1012), if there are no remaining base classes, i.e., the top-level base class has already been analyzed, the process of identifying properties ends (step 1009). If it is determined that a base class remains (step 1014), the base class is obtained as the class to be analyzed (step 1002).

With reference to FIG. 11, the steps associated with applying design patterns to identify public simple read-write properties is described in accordance with an embodiment of the present invention. A simple read-write property is one type of simple property, and is generally identified by a “set” method and a “get” method. For example, a simple property “foo” may be identified, or located, by looking for “getFoo” and “setFoo” methods. Other simple properties include, but are not limited to, read-only properties and write-only properties.

When a process of applying design patterns to identify public simple read-write properties begins (step 1102), the process enters a loop where a variable “I” is incremented. Here, a counter is used to track the number of methods that are to be checked in the identification of public simple read-write properties. The loop loops through all methods “I” that may be associated with the class that is being analyzed. If there are no methods to be checked, or, alternatively, if all available methods have been checked, then the process of identifying simple read-write properties ends (step 1103). As mentioned above, a simple read-write property may typically be identified by a set method and a get method. The process determines (step 1104) whether method “I” has the form “get<string>,” where “<string>,” is generally the name of the simple property that is to be located. If method “I” does not have the form “get<string>,” the process flow loops back where “I,” or a counter, is incremented (step 1102), and the next method, if any, is obtained.

If the method “I” does have the form “get<string>” (step 1104), a search is made for a method named “set<string>” (step 1106), where “<string>” is the same in both “get<string>” and “set<string>.” It should be appreciated that any suitable algorithm may be employed to search for a method named “set<string>” which may be located in the same class the method named “get<string>.” It is determined whether a method named “set<string>” has been found (step 1 108). If a method named “set<string>”has not been found, “I” is incremented (step 1102). It should be understood that when only a method named “get<string>” has been found, the property identified as “<string>” may be a read-only property. Alternatively, if a method named “set<string>” has been found, a determination is made as to whether the design pattern for a simple read-write property has been met (step 1110). Although the design pattern for a simple read-write property may take on any suitable form, the design pattern is such that “set<string>” returns a void and has one argument, while “get<string>” returns a result, which is of the same type as the argument to “set<string>,” and has no arguments.

If the design pattern for the simple read-write property has not been met, process flow returns to the counter where “I” is incremented (step 1102). If the design pattern for the simple read-write property has been met, “<string>” is added to a list of all simple read-write properties found. After “<string>” is added to the list of all simple read-write properties found, process flow returns to the counter where “I” is incremented (step 1102). Steps 1102 through 1112 are repeated until no more methods remain to be checked to determine if method “I” has the form “get<string>.” When no more methods remain to be checked, then the process of finding simple read-write properties ends (step 1103).

Referring next to FIG. 12, the steps associated with applying design patterns to identify public boolean properties is described. A boolean property may generally be identified by the presence of an “is” method and a corresponding “set” method. In some cases, a corresponding “get” method may also be present in addition to an “is” method. A boolean property, as for example “boolean prop,” may be identified, or located, by looking for “isBooleanprop” and “setBooleanprop” methods.

A process of applying design patterns to identify public boolean properties begins by entering a counter loop (step 1202), where a variable “I” is incremented. The loop loops through all methods “I” that may be associated with the class that is being analyzed. If there are no methods to be checked, or if all available methods have been checked, the process of identifying boolean properties ends (step 1203). The process determines (step 1204) whether method “I” has the form “is<string>.” If the method “I” does not have the form “is<string>,” the process flow loops back to step 1202 where “I” is incremented.

If the method “I” has the form “is<string>” (step 1204), a search is made for a method named “set<string>,” where “<string>” is the same in both “is<string>” and “set<string>.” The process determines whether a method named “set<string>” has been found (step 1208). If a method named “set<string>” is not found, process flow returns to step 1202 where “I” is incremented. However, if a method named “set<string>“ is found, it is determined whether the design pattern for a boolean property is met (step 1210). It should be appreciated that the design pattern for a boolean property may take on any suitable form. For example, the design pattern may be such that “set<string>” returns a void and has one boolean argument, while “is<string>” returns a boolean, and has no arguments.

If the design pattern for a boolean property is not met, then process flow returns to step 1202, where “I” is incremented. However, if the design pattern for a boolean property is met, “<string>” is added to a list of all boolean properties found (step 1212). After “<string>” is added to the list of all boolean properties found, process flow returns to step 1202 where “I” is incremented. Steps 1202 through 1212 are repeated until no more methods remain to be checked to determine if method “I” has the form “is<string>.” When no more methods remain to be checked, then the process of finding boolean properties ends (step 1203).

Referring next to FIG. 13, the steps associated with applying design patterns to identify public indexed properties is described. An indexed property is a property whose type is an array, and may generally be identified by a “set” method and a “get” method. For example, an indexed property “indexprop” may be identified, or located, by looking for “getIndexprop” and “setIndexprop” methods.

The process of applying design patterns to identify public indexed properties begins in a step 1302 where the process enters a counter loop where a variable “I” is incremented. The loop loops through all methods “I” that may be associated with the class that is being analyzed. If there are no methods to be checked, or, alternatively, if all available methods have been checked, the process of identifying indexed properties ends (step 1303). As discussed above, an indexed property may generally be identified by a set method and a get method. If the method “I” does not have the form “get<string>” (step 1304), process flow loops back to step 1302 where “I” is incremented.

If the method “I” does indeed have the form “get<string>” (step 1304), a search is made for a method named “set<string” (step 1306), where “string<string>” is the same in both “get<string>” and “set<string>.”It should be appreciated that known processes may be employed to search for a method named “set<string>” which may be located in the same class the method named “get<string>.” The process determines whether a method named “set<string>” has been found (step 1308). If a method named “set<string>” has not been found (step 1308), process flow returns to step 1302 where “I” is incremented. Alternatively, if a method named “set<string>” has been found (step 1308), the process determines whether the design pattern for indexed properties are met (step 1310). Although the design pattern for indexed properties may take on any suitable form, the design pattern is such that “get<string>” returns a result and takes one integer argument, while “set<string>” returns a void, and takes two arguments, the first being an integer, and the second being of the same type as the result returned by “get<string>.”

If the design pattern for indexed properties is not met, process flow returns to step 1302 where “I” is incremented. If the design pattern for the indexed properties is met, “<string>” is added to a list of indexed properties found (step 1312). After “<string>” is added to the list of all indexed properties found, process flow returns to step 1302 where “I” is incremented. Steps 1302 through 1312 are repeated until no more methods remain to be checked to determine if method “I” has the form “get<string>.” When no more methods remain to be checked, then the process of finding simple properties ends (step 1303).

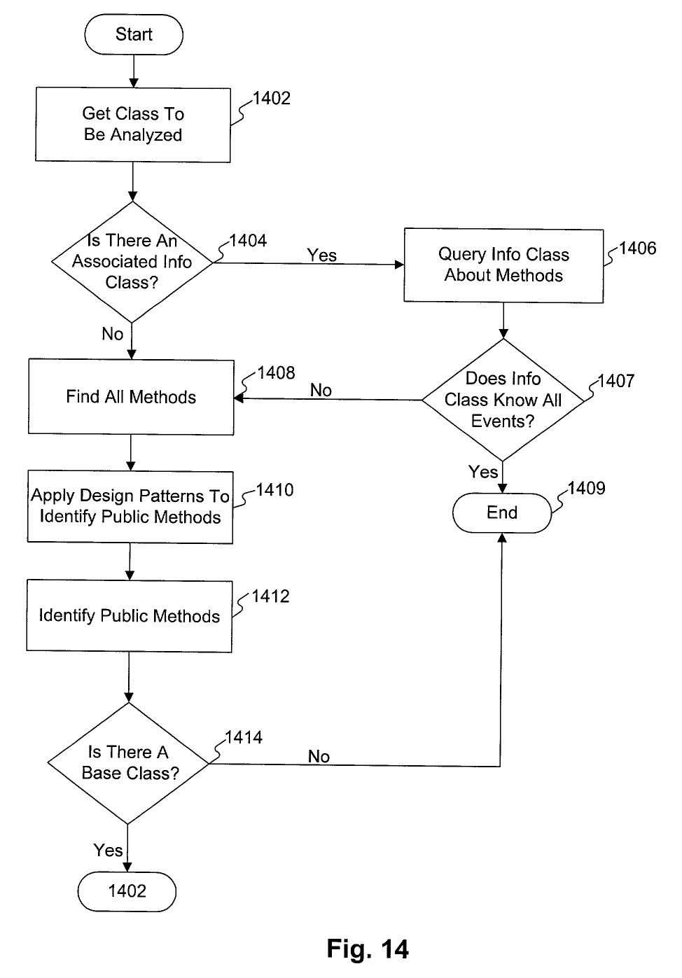

After methods and properties associated with a class are identified, the events associated with the class are then identified. FIG. 14 is a process flow diagram that illustrates the steps involved with identifying events associated with a class in accordance with an embodiment of the present invention. Events typically provide a way for one component to notify other components that something of interest has occurred. After the class to be analyzed is obtained (step 1402), if an associated component information class is in exists, the information class is queried about events contained within the information class (step 1406). If it is determined that all events are known to the information class (step 1407), the process of identifying events associated with a class ends (step 1409). If it is determined that all events are not known to the information class, all methods associated with the class that is being analyzed are found (step 1408). While any appropriate process may be used to find methods, a reflection process is typically used to identify all events associated with a class.

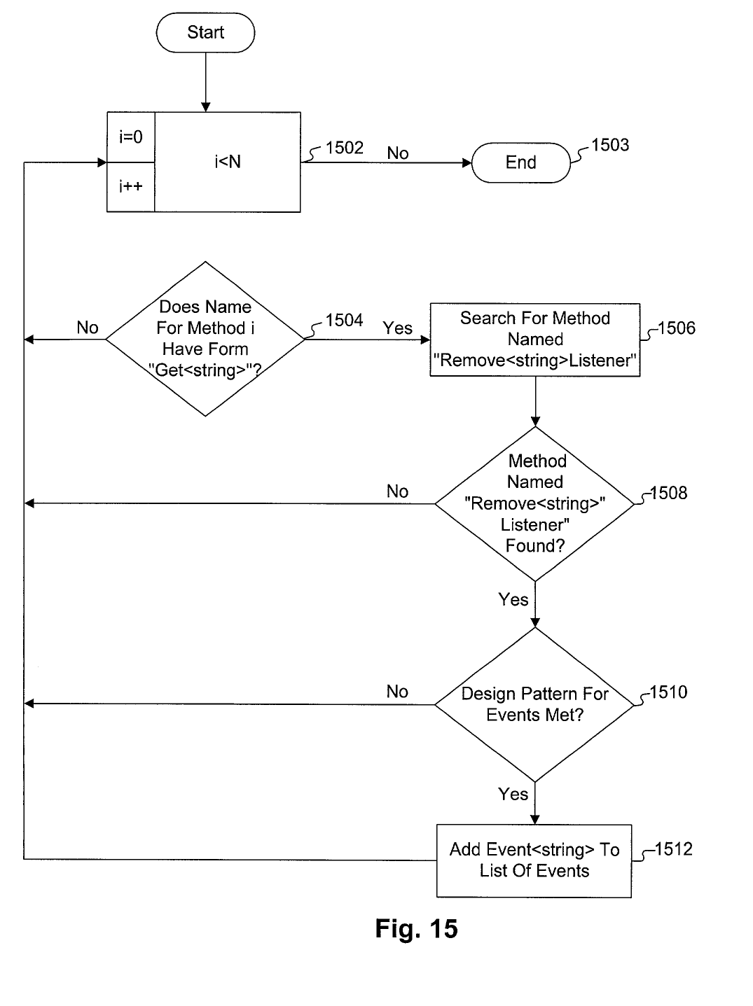

After all methods are identified, design patterns are applied to identify public events (step 1410). The design patterns may be standard design patterns that may be used to identify public events that are associated with the class that is being analyzed. A public event is an event that is accessible to, e.g., may be exported to, classes other than the class with which the public event is associated. One suitable process of identifying public events will be described in more detail below with respect to FIG. 15. After the public events are identified (step 1412), the process determines whether there is a base class. When it is determined that the top-level base class has already been analyzed, the process of identifying events ends (step 1409). If a base class exists (step 1414), the base class becomes the class to be analyzed, and process flow returns to step 1402.

Referring next to FIG. 15, the steps associated with applying design patterns to identify public events will be described. The process of applying design patterns to identify public events begins in a counter loop where a variable “I” is incremented (step 1502). The loop loops through all methods “I” that may be associated with the class that is being analyzed. If there are no methods to be checked, or, alternatively, if all available methods have been checked, the process of identifying public events ends (step 1503). In general, an event may be identified by an add method and a remove method. If the method “I” does not have the form “add<string>listener” (step 1504), the process loops back to step 1502 where “I” is incremented.

If the method “I” does have the form “add<string>listener” (step 1504), a search is made for a method named “remove<string>listener” (step 1506), where “<string>” is the same in both “add<string>listener” and “remove<string>listener.” It should be appreciated that known processes may be employed to search for a method named “add<string>listener.” In a step 908, it is determined whether a method named “remove<string>listener” has been found. If a method named “remove<string>listener” has not been found (step 1502), process flow returns to step 1502 where “I” is incremented. Alternatively, if a method named “remove<string>listener” has been found (step 1502), the process determines whether the design pattern for a public event is met (step 1510). Although the design pattern for a public event may take on any suitable form, the design pattern is such that “add<string>listener” returns a void and has one argument, and “remove<string>listener” returns a void and has one argument which is of the same type as the argument to “add<string>listener.”

If the design pattern for a public event has not been met (step 1510), then process flow returns to step 1502 where “I” is incremented. If the design pattern for the public event is met, “<string>” is added to a list of all public events found (step 1512). After “<string>” is added to the list of all public events found, process flow returns to step 1502 where “I” is incremented. Steps 1502 through 1512 are repeated until no more methods remain to be checked to determine if method “I” has the form “add<string>listener.” When no more methods remain to be checked, then the process of finding public events ends (step 1503).

Although several implementations consistent with the principles of the present invention have been described, it should be understood that these principles may be implemented in many other forms without departing from the scope of the present invention. It will be understood by those skilled in the art that various changes and modifications may be made, and equivalents may be substituted for elements thereof without departing from the scope of the invention. Modifications may be made to adapt a particular element, technique, or implementation to the teachings of the present invention without departing from the scope of the invention.

For example, other processes may be implemented to determine, starting from the remote interface of an entity bean, the columns to be presented to a client through the table bridge. For example, the following process (referred to as a “property analysis”) can be applied to any Java class (or interface) and results in a set of columns described by their name, type and writability status (i.e. whether a column is read-only or readable and writable).

The overall process used when analyzing the remote interface of an entity bean consists of invoking the property analysis process with the remote interface as an argument. The property analysis process begins by introspecting the target class using Java Beans conventions. Then a review is made of all the properties that have been found and all non-readable properties are discarded. For each readable property, if its type is one that can be immediately mapped to a column type (e.g. string, int, float . . . ), a corresponding column is created with the type found; the column will be writable only if the property discovered by introspection was writable. If the type was not a simple one, such as a general java class with several fields and methods, the process of analysis is reiterated operating on the type of the property found (in this case, the original property discovered has a sub-object as its value).

This is a general description of the property analysis but those skilled in the art will recognize that it may be necessary to consider certain factors when implementing this process, namely:

(1)When a sub-object is analyzed and a property is found in it, the corresponding column will be writable if and only if the immediate property for it was writable and all the properties used to access the sub-object were writable (notice that there could be a chain of sub-objects that lead to the one with the property in question).

(2) Unlike in the Java Beans introspection case, the same algorithm described above is used for all public fields of the Java class in question, basically treating them as ‘properties’ (although they are not such in the Java Beans sense).

(3) When deciding if a property is writable, the presence of a setXXX( ) method is taken into account (as done by the Java Beans introspection process), as well as all constructors for the class, and using user-supplied information an attempt is made to see if there is a way, when updating a property of a sub-object, to construct a new instance of it using a constructor that takes the value for the given property as an argument. This was added to the process to support the common case where all the properties (in the Java Beans sense) are read-only but there is a constructor on the class under analysis that takes as arguments the initial values for all those properties. In this case, this process will make the columns corresponding to those properties writable when they would have been writable otherwise.

It should also be appreciated that steps involved with analyzing classes or performing other processes consistent with the present invention may be reordered. Steps may also be removed or added without departing from the scope of the present invention. Although the described implementation is discussed specifically in terms of software, the invention may be implemented as a combination of hardware and software. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet; or other forms of RAM or ROM. Therefore, the described implementations should be taken as illustrative and not restrictive, of the invention defined by the following claims and their scope of equivalents.

What is claimed is:

1. A computer implementation method, comprising:
receiving database record information at a client computer system from a database server;
modifying the database record information at said client computer system using a first computer programming language;
transmitting the database record information with modifications to an application server;
converting the modifications, at the application server, to calls of a second computer programming language of a computer application; and
executing the second computer language programming calls to invoke functions of the computer application to cause database record changes at said database server that correspond to the modifications to the database record information.

2. The method of claim 1 further comprising the step of determining when a user has completed making changes to said database record information at said client computer system.

3. The method of claim 1 wherein said step of transmitting said modifications to said application server comprises transmitting to said application server a list of changes made to said database record information.

4. The method of claim 3 wherein said application server determines the changes that have been made to said database record information from said list and converts said changes to functions of said application that cause modifications to a database record of said database server that corresponds to the modifications made at said client computer system.

5. The method of claim 1 wherein said database record information represents at least a subset of a table of said database server and said step of modifying comprises inserting an element in said subset of said table at said client computer system.

6. The method of claim 5 further comprising determining, at said application server, an EJB object that corresponds to the table subset modified at said client computer system; and creating a map to enable inserts into a table of said database server that corresponds to said step of inserting at said client computer system.

7. The method of claim 6 further comprising:
identifying all create methods of said EJB object and of sub-objects of said EJB object;
determining which columns of tables of said database correspond to arguments of identified create methods; and
wherein said step of creating said map comprises mapping said columns to arguments of the create methods that correspond to said columns.

8. The method of claim 7 further comprising determining, at said application server, the location of the insert into said subset of said table and mapping the element inserted into said subset to an argument of the identified create method that is operative to cause said element to be inserted into said table of said database server.

9. The method of claim 8 further comprising executing the identified create method, at the application server, to cause the element to be inserted in said table of said database.

10. A method of interfacing between a client computer system and a database server, comprising the following steps:
receiving, at an application server, a set of commands from a client computer system to modify a database record of a database server;
identifying certain application instructions of an application, at said application server, that are operative to insert elements into a database record;
enabling said certain application instructions to be correlated to certain commands received from said client computer system that indicate the insertion of an element into said database record;
executing selected certain application instructions that correspond to said certain commands, wherein execution of said selected certain application instructions cause the invocation of a database call to insert elements into said database record corresponding to said certain commands.

11. The method of claim 10 wherein said step of identifying occurs when said application is being configured for execution at said application server.

12. The method of claim 11 wherein said step of enabling comprises identifying columns of database records that may be operated on by the identified certain application instructions.

13. The method of claim 12 further comprising mapping the columns that may be operated on to the identified certain application instructions.

14. The method of claim 13 further comprising updating elements the columns associated with the identified application instructions based on the certain commands.

15. The method of claim 14 wherein said commands are from a different type database access protocol language than said certain application instructions.

16. The method of claim 15 wherein said step of identifying said certain application instructions comprises identifying create methods.

17. The method of claim 16 wherein said database record is a table of said database.

18. The method of claim 17 wherein said create method is part of an EJB that accesses the table.

19. The method of claim 18 wherein said EJB is identified prior to identifying said create methods.

20. A computer readable medium, operative to serve as a database interface, having instructions which when executed by a computer system perform a method comprising the following steps:
identifying first level software components of an application on an application server, that contain sub-level software components, said sub-level software components for accessing data input fields of a database;
exposing the first level software components in association with operations of sub-level software components for accessing the information contained in the data input fields;
mapping modification commands received, at the application server, from a client computer system to the identified first level and sub-level software components that correspond to the modification commands; and
executing the identified software components to update said database in accordance with the modifications received from the client computer system.

21. The medium of claim 20 wherein said first level software components is an EJB object and said sub-level software components are sub-objects of said EJB object.

22. The medium of claim 20 wherein said step of executing comprises executing software components that produce SQL calls to said database to modify said database.

23. The medium of claim 20 wherein said modification commands are from an application designed for direct access to a relational database.

24. The medium of claim 23 wherein said identified first level and sub-level software components are EJB components.

25. A computer implemented method for interfacing between a client computer system and a database server, comprising the following steps:
receiving, at the application server, the result of a query request as modified by a client computer system;
determining, at the application server, the modifications made to the result of the query request;
converting, at said application server, the modifications from a first programming language into a general computer programming language command for accessing a database; and
executing said general programming language command to produce a database protocol command to modify a database record to correspond to the query request as modified by the client computer system.

26. The method of claim 25 wherein said general computer language programming call is an Enterprise Java Bean (EJB) call.

27. The method of claim 25 wherein the database protocol command is a Structured Query Logic (SQL) call.

28. The method of claim 25 wherein the application server receives the database call from a client computer system.

29. The method of claim 25 further comprising generating a database call to a database in response to executing the general computer language programming call.

30. The method of claim 25 further comprising generating database calls to a database in response to executing the general computer language programming calls;
analyzing the components to determine the correspondence between database elements and the elements of the components that access the database elements; and
creating a map that identifies the correspondence.
